(19) United States
(12) Patent Application Publication
(10) Pub. No.: US 2004/0007104 A1
(43) Pub. Date: Jan. 15, 2004

(54) Remote enclosed mail opener

(76) Inventor: Bruce Soderman, Dewey, AZ (US)

Correspondence Address: Bruce Soderman, P.O. Box 511, Dewey, AZ, 86327, US

(21) Appl. No.: 10/193,344

(22) Filed: Jul. 12, 2002

(51) Int. Cl. B26D 1/00

(52) U.S. Cl. 83/13

(57) ABSTRACT

A rectangular tray 11 with a hinged cover 16 and a gripping mechanism 37 for various sized envelopes to fit into a box shaped device 10 with a rectangular upper opening 20 leading horizontally to a motorized cutter 23 above a moveable tray 31 which communicates with a rectangular lower opening 21.

This is a detailed version of the Disclosure Document I sent to the PTO on Jan. 14, 2002.

### BACKGROUND

1. Field of Invention

This invention relates to postal security, personal safety, and specifically to a machine, to open and display the contents of a suspicious envelope, keeping it all inside a metal enclosure designed to prevent the spread of toxins or to muffle an explosion.

2. Description of Prior Art

I have not found any prior art relating to an enclosed mail opener or a scoop used to pick up an envelope. This invention occurred to me soon after the first Anthrax letters made headlines in October 2002.

### OBJECTS AND ADVANTAGES

Accordingly, the main advantage of my invention is safety. A person can easily use the Scoop, mounted on the end of the Remote Control Pole, to pick up a dangerous envelope without actually touching the envelope. The Scoop has a hinged plexi-glass lid, which helps to reduce the spread of poisons.

### DRAWING FIGURES

In the drawings, closely related figures have the same numbers, but different alphabetic suffixes.

FIG. 1 shows the Scoop and the REMO.

FIG. 2 shows an operator using the Rake to pull an envelope into the Scoop.

FIG. 3 shows the Scoop being transported to the REMO.

FIG. 4 shows the envelope being opened inside the REMO.

FIG. 5 shows the contents of the envelope being dumped onto the Inspection Tray.

FIG. 6 shows the Inspection Tray tilting to dump the envelope and its contents out the Exit Chute.

FIG. 7 shows details of the Scoop.

FIG. 8 shows details of the REMO.

### REFERENCE NUMERALS IN DRAWINGS

10 Remote Enclosed Mail Opener—REMO

11 Scoop

12 Remote Control Pole

13 Rake

14 Rake Stop

15 Scoop Handle

16 Hinged Lid

17 Hinged Lid Lifter

18 Hinged Lid Cord

19 Dump Cord

20 REMO Entrance

21 REMO Exit

22 Plexi-Glass Top

23 Cutter Motor

24 Cutter Blade

25 Cutter Track

26 Support Bar

27 Pulley

28 Pulley Cord

29 Grabber Spring

30 Envelope

31 Inspection Tray

32 Inspection Tray Shaft

33 Inspection Tray Handle

34 Inspection Tray Door

35 Inspection Tray Lever

36 Rolling Shield

37 Grabber

38 Grabber Slot

39 Grabber Stop

40 Grabber Lever

41 Grabber Cord

42 Video Camera

43 Exit Chute

44 Exit Door

45 Exit Lever

46 Exit Cord

47 Grabber Release Cord

### SUMMARY

In accordance with the present invention, a Remote Enclosed Mail Opener, or REMO, is comprised of a, a Rake, a Remote Control Pole, a Scoop and a Remote Enclosed Mail Opener, which includes a Cutter, an Inspection Tray, and an Exit Chute.

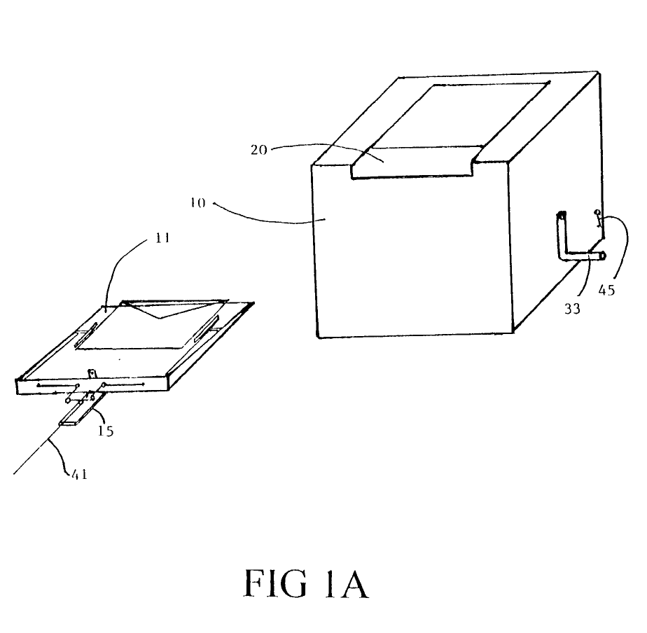

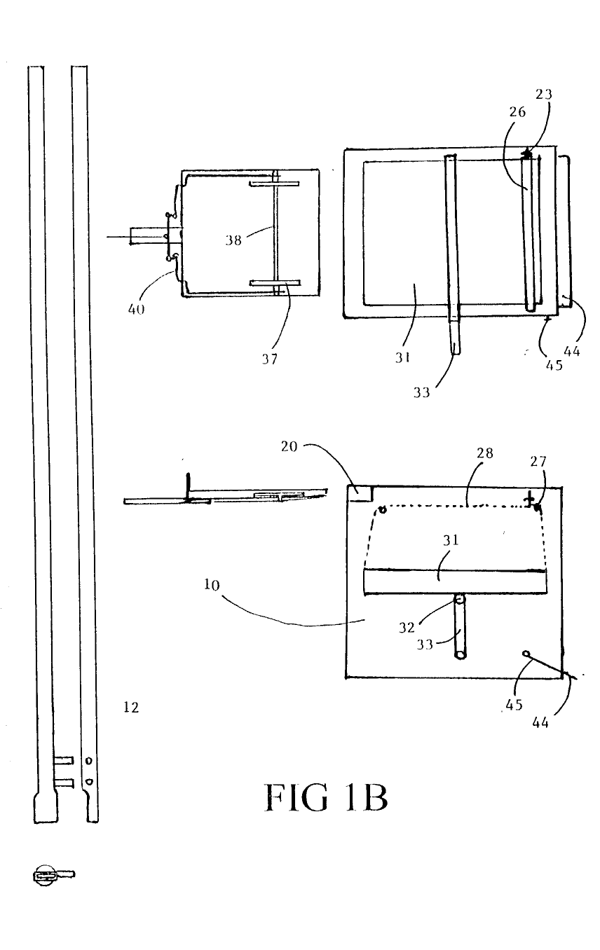

### DESCRIPTION—FIGS. 1,4,7,8

A typical embodiment of the Remote Enclosed Mail Opener 10, is illustrated in FIG. 1A (elevated view), and FIG. 1B (top and end views). It is a sheet metal box, enclosing an envelope Cutter 23, an Inspection Tray 31, and an Exit Chute 43. The REMO may be mounted on wheels or bolted to the floor, and comes equipped with a fixed plexi-glass top 22 and/or a video camera 42 to safely view the contents of the envelope. The Scoop 11, illustrated in FIGS. 1C+D and 8C+D. It is a tray made of metal, or plastic with a Hinged Lid 16, a Grabber Slot 38, with two Grabbers 37 to hold the envelope during the cutting and dumping operations. FIG. 1B also shows the Remote Control Pole 12 with the two dowels at the bottom designed to slide over the Inspection Tray Handle 33, as well as the flattened end designed to slide onto the Scoop Handle 15.

FIG. 1C shows how the Rake 13, is used to pull the envelope into the Scoop, and is equipped with two Stops 14, which serve to position the envelope with approximately ¼ inch outside the Scoop for cutting.

The Scoop is equipped with a Handle 15, which fits into the Remote Control Pole 12 for safe transportation to the REMO.

FIG. 1A shows a rectangular Entrance 20 near the top of the REMO for inserting the Scoop horizontally, until it slides over a s Support Bar 26, for the cutting operation. The Cutter Motor 23 is equipped with a circular blade 24, and is mounted on a square shaft positioned to cut ⅛ inch from the edge of the envelope.

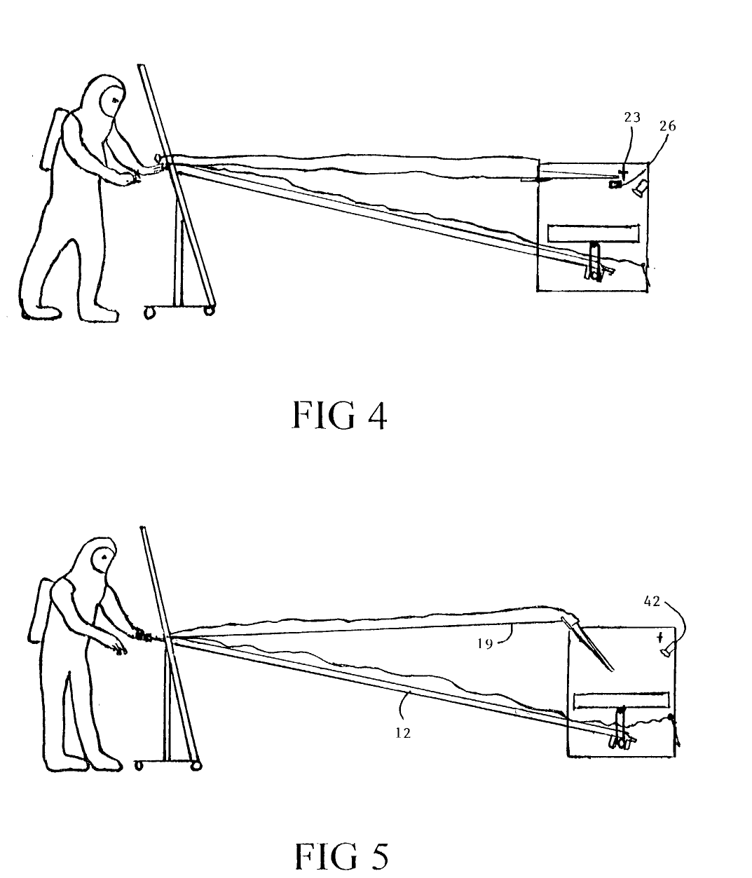

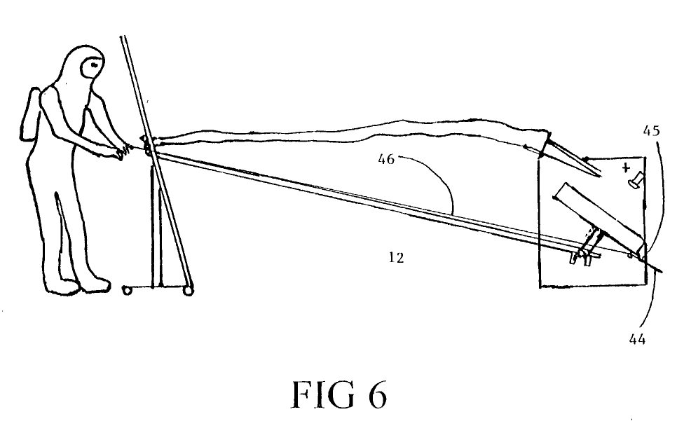

The Video Camera 42 is shown in FIG. 4, mounted above the Inspection Tray 31.

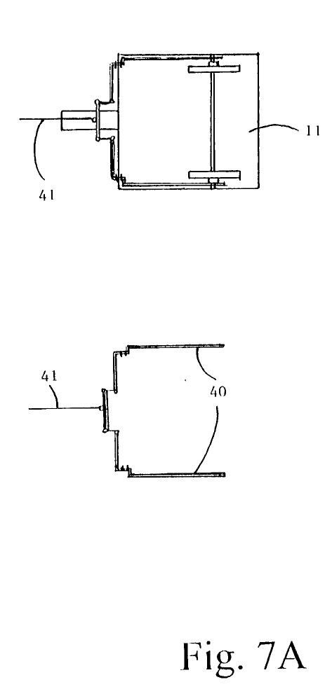

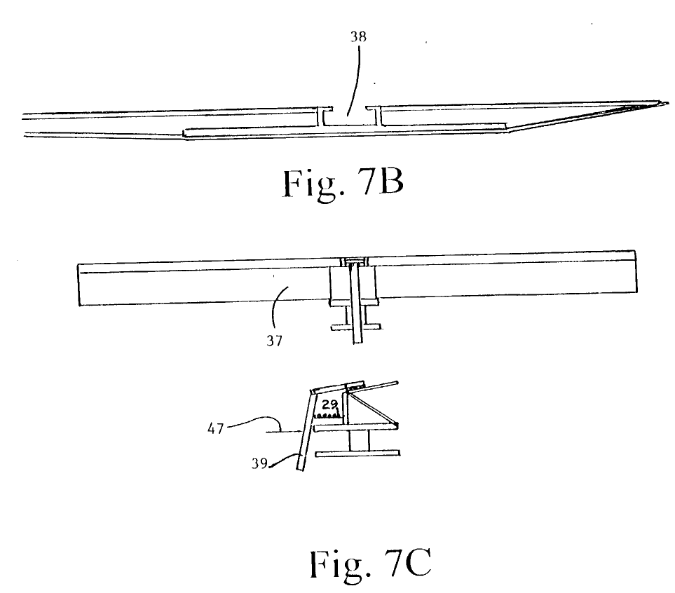

FIG. 7A shows details of the Scoop and Grabber mechanism, including the Grabber Lever 40 and Grabber Cord 41. FIG. 7B shows an actual size cross- section of the Grabber Slot 38. FIG. C shows an actual size side view and end view of the Grabber 37, including the Grabber Stop 39, which holds the envelope in place during the dumping operation.

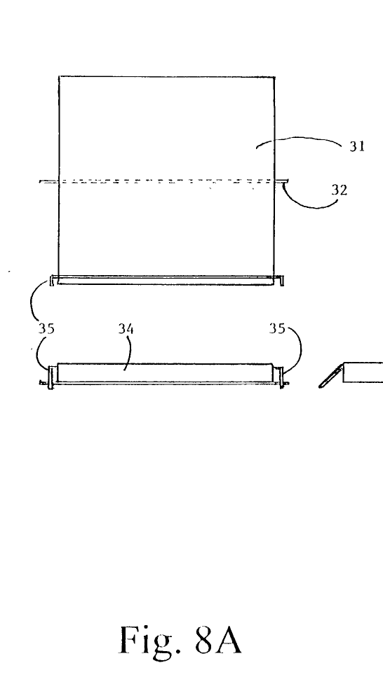

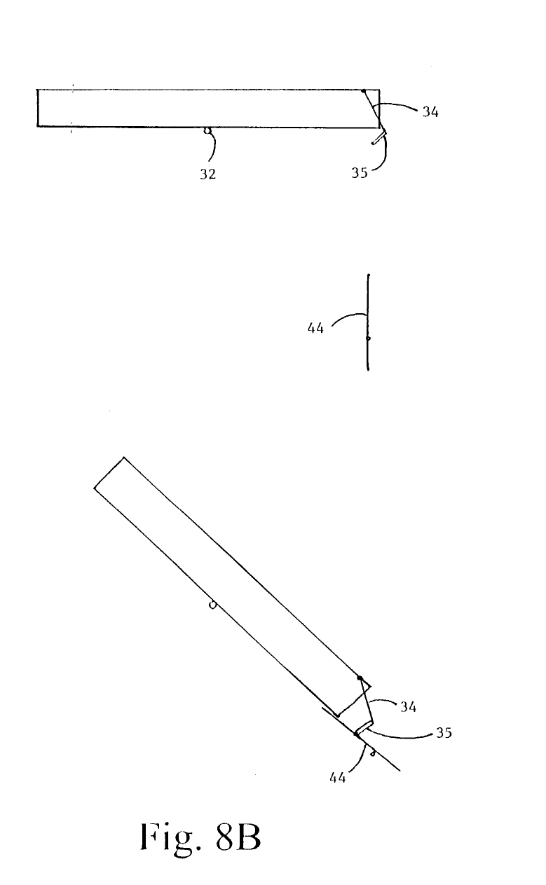

FIGS. 8A+B shows details of the Inspection Tray 31 and how the Inspection Tray Door 34 opens when the Exit Door 44 is pivoted inwards to contact the Inspection Tray Lever 35. The Inspection Tray is mounted about twelve inches below the cutter to catch the contents of the envelope after it is dumped. The Inspection Tray is mounted on a rotating shaft 32, to rock the contents back and forth, about 60 degrees in each direction. The Inspection Tray may be connected by a pulley system to move the Cutter motor, as shown in FIG. 1B, or moved by a motor.

The Exit Chute 43, shown on FIGS. 1B and 8B+C, is located beneath the Inspection Tray and pivots inward about 45 degrees to a position which automatically opens the Door 34 on one side of the Inspection Tray, when the Inspection Door tilts down. When the Inspection Door opens, the envelope and its contents automatically slide out of the Inspection Tray through the Exit Chute 43.

### OPERATION_FIGS. 2,3,4,5,6

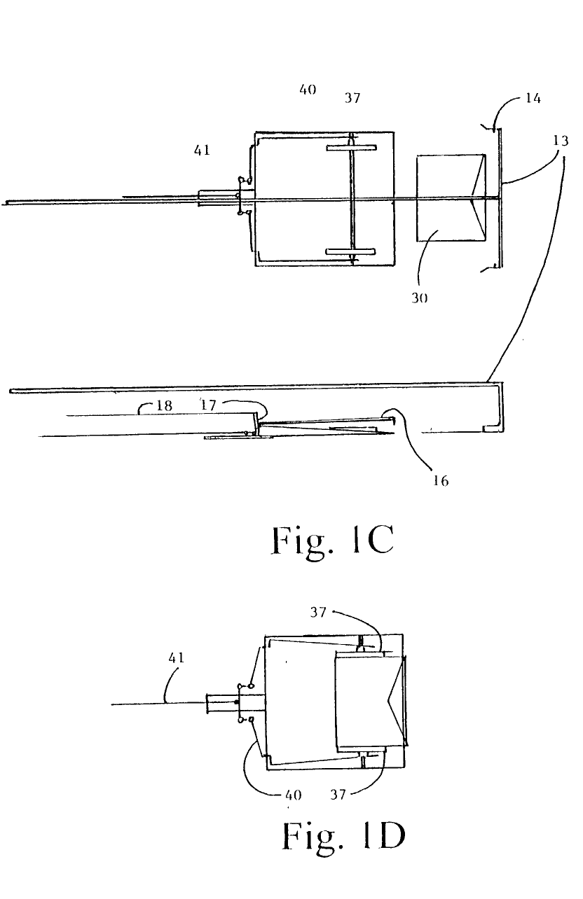

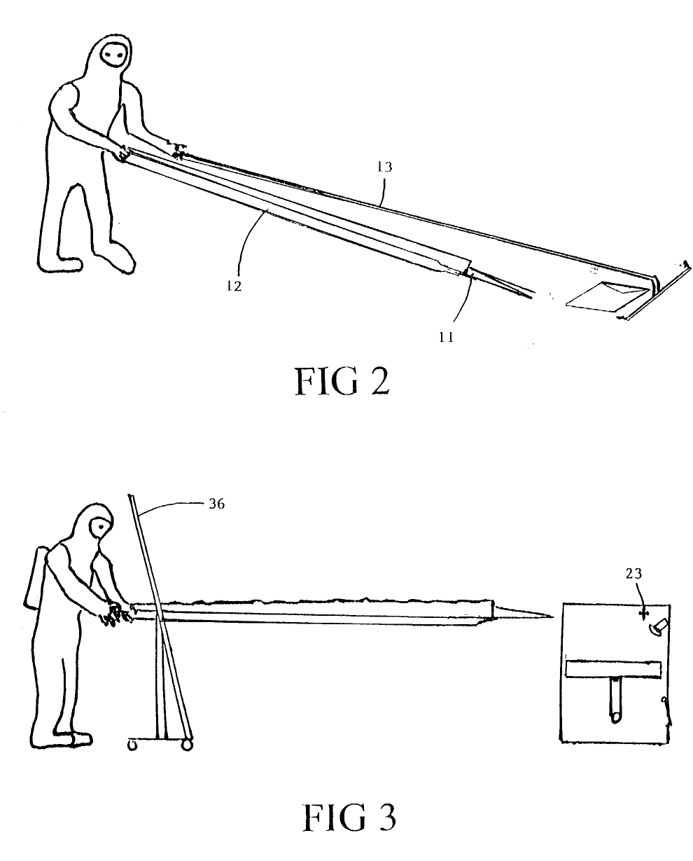

The manner of operating the REMO is shown in FIG. 2 where the operator uses the Remote control Pole 12 to push the Scoop toward the side of an envelope. The operator pulls the Hinged Lid Cord 18 to open the Hinged Lid 16, and then uses the Rake 13 to pull the envelope into the Scoop. The operator then releases the Lid Cord to close the lid on the envelope to prevent the spread of any toxins.

FIG. 3 shows the operator transporting the Scoop to the REMO by means of a Rolling Shield 36. Once the Scoop is inserted into the REMO, the Remote Control Pole is with drawn from the Scoop with a slight tug and is fitted over the Inspection Tray Handle 33 for the cutting operation.

After the envelope is cut open, the operator pulls the dump cord 19, shown on FIG. 5, which moves the Scoop backwards one inch where it is no longer resting on the support bar 26, and the Scoop automatically falls downward 60 degrees to dump its contents onto the Inspection Tray. The two Grabbers 37 hold the envelope in place as its contents fall out.

The operator pulls and pushes the remote control pole against the Inspection Tray Handle so that the contents of the envelope can be observed through the plexi-glass top 22 or video camera 42. If the contents appear safe, the Grabber levers 40 are released so that the envelope falls out of their grasp onto the Inspection Tray.

FIG. 7C shows the Grabber Stop 39, which is hinged at the top so that it can slide inward to hold the envelope, but can not slide outward because the bottom of the Grabber Stop is coated with a rubber compound such as RTV automotive glue, causing it to jam against the bottom of the Grabber Slot and hold the envelope in place.

When the operator releases the Grabber Levers, they automatically pull on the Grabber Release Cord 47, which releases the Grabber Stop. The operator then pulls the Exit Cord 46 and uses the Remote Control Pole to push on the Inspection Tray Handle 33 to pivot the Inspection Tray down to make contact with the Exit Lever 45, which opens the Exit Door 44, allowing the envelope and contents slide down the Exit Chute 43.

### CONCLUSION, RAMIFICATIONS, AND SCOPE

Accordingly, the reader will see that this invention can be used to open a suspicious looking envelope and view its contents through a plexi-glass window, or video camera from a safe distance behind a blast proof barrier, if necessary. Furthermore, this invention has the additional advantage in that it provides a metal enclosure to prevent the spread of poisons and serves to muffle an explosion. It can be mounted on wheels and easily moved to a place for disposal, or bolted to the floor in a blast proof room.

### ADDITIONAL RAMIFICATIONS

Although the description above contains many specifics, these should not be construed as limiting the scope of this invention, but merely illustrations of the simplest embodiments of this invention. For example, the cutting and dumping operations can be completely automated to work by pushing buttons on a radio control device.

Thus the scope of the invention should be determined by the appended claims and their legal equivalents rather than by the examples given.

I claim:

1. A method and a device for inspecting contents of an envelope, comprising the steps of:
(A) picking up said envelope
(B) opening said envelope
(C) extracting said contents of said envelope, whereby said contents can be safely observed within an enclosure.
